(19) United States
(12) Patent Application Publication
(10) Pub. No.: US 2014/0371897 A1
(43) Pub. Date: Dec. 18, 2014

(54) CO-LOCATED SCANNING, PRINTING AND/OR MACHINING DEVICES FOR MEDICAL CONSTRUCTS

(71) Applicant: OSIRIS BIOMED 3D, LLC, Roslindale, MA (US)

(72) Inventors: Samuel Jui-Wen LIN, Needham, MA (US); Bernard T. LEE, Chestnut Hill, MA (US); Theodore L. GERSTLE, Roslindale, MA (US)

(21) Appl. No.: 14/304,908

(22) Filed: Jun. 14, 2014

Related U.S. Application Data
(60) Provisional application No. 61/835,495, filed on Jun. 14, 2013.
(60) Provisional application No. 61/873,354, filed on Sep. 3, 2013.

(51) Int. Cl. G05B 19/4099; G06F 17/30; H04N 1/00

(52) U.S. Cl. CPC G05B 19/4099; H04N 1/00827; H04N 1/00278; G06F 17/30244
USPC 700/118

(57) ABSTRACT

The present disclosure provides devices and methods for obtaining images of body parts, implants, bones, and other areas of a patient that are involved in plastic or reconstructive surgery. A scanning device obtains an image of a body part of a patient to be replicated, sends it to a computer for review and/or manipulation, and the computer sends it to a printer or fabricator for reproduction. The scanning device, computer, and/or printer can be co-located, meaning that they are within the same facility. As an alternative to scanning the patient's body part, the computer of the present disclosure can obtain an image of the required body part from a stored set of anthropometric data on a database. The surgeon can modify the part produced from the anthropometric data as needed.

### CROSS-REFERENCE TO RELATED APPLICATIONS

The present application claims priority to U.S. Provisional Patent No. 61/835,495, filed on Jun. 14, 2013, and U.S. Provisional Patent No. 61/873,354, filed on Sep. 3, 2013, each of which is incorporated by reference.

### BACKGROUND OF THE DISCLOSURE

1. Field of the Disclosure

The present disclosure relates to methods and devices for scanning and printing custom implants, prostheses, bone replacements, cutting guides for osteotomy and tissue resection, anatomic models, medical instruments, splints, prosthetics, body parts, and organs for medical applications. More particularly, the present disclosure relates to such devices and methods where the scanning and printing devices are co-located for ultra-rapid prototyping during a single anesthetic. The methods and devices of the present disclosure can also use anthropometric normative data to produce a missing part or design the part in the absence of prior imaging.

2. Description of the Related Art

Three-dimensional medical printing currently represents a niche market which is costly, labor intensive, and narrowly limited to only a few applications. Most importantly, current devices and methods take between twenty-four (24) hours and thirty (30) days to produce a device capable of helping a patient. Current devices or methods may utilize a procedure by which a doctor wishing to develop a three-dimensional construct (such as a replacement organ, bone, model, prosthesis, or implant) takes an image of the relevant area or part of the patient's body, and then sends the image off to a remote site to create the product. After days to weeks, the product that arrives is often a poor fit and may require a second production cycle, leading to a further delay in treatment, and in many cases, a second surgery. Second surgeries can present a host of complications and danger to the patient, as well as a significant amount of discomfort and emotional distress, as the surgical wound site will often have to be kept open between surgeries.

The present disclosure provides devices and methods for overcoming these deficiencies with an on-site rapid prototyping model that will be placed within the operating room, allowing the surgeon to create 3-D constructs immediately using previously obtained imaging, anthropometric normative data, or on-the-fly design.

### SUMMARY OF THE DISCLOSURE

The present disclosure provides devices and methods for producing a three-dimensional construct such as a prosthesis, bony replacement, splint for guiding bony healing, cutting guide, surgical tool, or implant, with devices that can be co-located, and all during a single surgical procedure. The three dimensional data set used to make the three-dimensional construct for the patient may be acquired by devices such as laser scanners, haptic interfaces, digital photography, CT/MRI scan, and intraoperative photos with subsequent CAD/CAM manipulation of this data.

The present disclosure also provides a process for producing surgical three-dimensional constructs during a single operation utilizing on-site manufacturing with co-located scanning, computer manipulation of three-dimensional data, and creation of replacement body parts, surgical models, cutting guides, and surgical instruments.

In an additional embodiment, and in the absence of previous radiologic imaging or the ability to scan or collect data for the three-dimensional construct during the operation or on site (e.g. via 3D imaging), the present disclosure can provide a dataset collected from anthropometric norms that may be used to obtain a 99% true fit simply through scaling the part selected from male and female head to toe virtual models. A computer software program can be pre-loaded with printable body parts that are scaleable and able to be modified by the surgeon or a technician under the surgeon's direction. The computer used during the surgical procedure can also be set up to access a remote database with normative data for the three-dimensional construct. The stored anthropometric norms can be obtained through a comparative analysis of a range of varying CT scans, yielding the skeletal norms encompassing two standard deviations.

For ease of description, the term “three-dimensional construct” or simply “construct” is used in the present disclosure to refer to the objects produced by the printing devices in the manner described below. These three-dimensional constructs can include implants, bone replacements, tissue replacements, prostheses, cutting guides, jigs, anatomic models, medical instruments, surgical tools, or even whole organs, which can be designed and created in the devices and methods of the present disclosure. Thus, the term “three-dimensional construct” as used in the present disclosure may refer to customized facial implants (bony or soft tissue implantation), facial fractures and repair, microtia framework, ocular prostheses, nasal prostheses, maxillary prostheses, palatal prostheses, septal prostheses, cranial vault prostheses, mandibular bone replacement (bone graft printout), maxillary bone replacement, customized pectoralis implants, customized buttock implants, customized soft tissue implant (all areas of the body inclusive), hand/extremity implants/prostheses, joint replacement (e.g., small joints of the wrist/fingers), large joint replacement (e.g., hips, knees, shoulder), spine corpus replacement, pelvic ring replacement, cardiac valves, cardiac stents, vascular conduits, long bone replacement (femur, tibia, fibula, radius, ulna, humerus), sternum/rib cage replacements, pelvic defect repairs, large joint replacements, non-implantable prosthetics (e.g., fingers, other appendages, limbs, orthotics, or obturators), combinations thereof, externally worn splints/braces, prosthetic part replacement for functional or aesthetic requirements, or other suitable implants. The term “implant device” may be used to refer to customized devices, such as mechanical hearts, customized covers and/or enclosures for existing devices such as pace makers (e.g. making them more comfortable or conforming them to unique bone configurations). Additionally, the methods and devices of the present disclosure can be used to create and plan osteotomies, and soft tissue resection during the precious minutes of composite tissue transplantation when the time limitations of tissue viability are limited to 2-3 hours and current technologies cannot possibly allow for three dimensional tailoring or planning of donor and recipient tissues.

Thus, in one embodiment, the present disclosure provides a process for producing a three-dimensional construct for a surgical procedure on a patient. The process comprises the steps of acquiring an image of the three-dimensional construct, displaying the image on a display device, sending the image to a printer, and printing the three-dimensional construct according to the image on the printer. In one embodiment, the printer is co-located in the same facility as the patient during the procedure. The display device can also be an interactive computer, and the method can further comprise the step of allowing a user to modify the image on the computer before sending the image to the printer.

In another embodiment, the present disclosure provides a medical apparatus for use during a surgical procedure. The apparatus comprises a scanning device for obtaining image data relating to a three-dimensional construct to be used during the surgical procedure, a computing device to display an image of the three-dimensional construct, and a printer for printing the three-dimensional construct. The computing device sends image data relating to the three-dimensional construct to the printer, to print the three-dimensional construct. At least one of the scanning device, computing device, and printer are co-located in the same facility where the surgical procedure takes place.

### BRIEF DESCRIPTION OF THE DRAWINGS

FIG. 1 shows a conceptualized block diagram of a configuration of the devices of the present disclosure.

FIG. 2 shows a schematic flow chart of the process of the present disclosure.

### DETAILED DESCRIPTION OF THE DISCLOSURE

The present disclosure provides devices and methods for ultra-rapid prototyping of three-dimensional constructs to be used during a surgery, thus limiting the risk associated with multiple surgeries and avoiding the currently necessary waiting period. The devices used in the present disclosure include an image acquisition device, a computer and image manipulation/display device, and a printer or fabricator for printing the three-dimensional construct. The devices and methods used for acquiring and printing the three-dimensional constructs, and in particular the printers, can be co-located with each other and the location of the surgery, meaning that they are in the same room or facility as the surgery taking place. The co-location or on-site presence of the printing devices enables the surgery, when applicable or desirable, to take place while the patient is under a single anesthetic. On-site location of the printing device, and single surgery or single anesthetic part replacement prevents the complications of longer or repeat surgery and also allows the surgeon more intraoperative tailoring of the part. Co-locating the scanning, computing, and/or printing devices facilitates the ability to perform the surgery quickly, even if adjustment of the construct is needed, and under a single anesthetic. This capability is currently impossible.

Thus, in one embodiment of the present disclosure, during a procedure, a surgeon, technician, or other user could acquire an image of a desired three-dimensional construct for use during the surgery. As described above, the three-dimensional construct could be a prosthetic or implant, in which case the user would acquire an image of area the patient's body to be operated on. (For example, a facial scan for an orbital bone implant or replacement.) The scanned image can then be sent to a viewing or computing device for review by the user. Once the image of the implement is acceptable, the user can send a command to the printer to print the implement. As the image acquisition device, display, and printer can be co-located, the user will have the implement while the patient is under a single anesthetic. This presents a dramatic improvement over currently available methods for printing surgical implements.

By “co-located” or “on site”, the present disclosure means that the scanning device, computer, and/or printer or fabricator, and in particular the printer, are located within the same room where the procedure is taking place, scaled to fit in the operating room itself. “Co-located” could signify that the image manipulation device and/or the printer/fabricator may be in separate rooms, but within the same hospital or medical care facility. Either way, the devices and methods of the present disclosure are co-located or “on site” with one another in the location where the surgical procedure is performed, so that ultra-rapid prototyping is possible during a single anesthetic, or single procedure, eliminating or significantly reducing the amount of delay in obtaining a required three-dimensional construct. In one embodiment, only the printer is located on site at the location where the surgical procedure is performed. Again, this can be in the same operating room as the patient, or in the same facility, so that ultra-rapid prototyping is possible. This process substantially decreases the cost of healthcare delivery, not just for the individual three-dimensional construct, but it also obviates the need for the current massive warehoused stock kept by hospitals, doctor offices, and surgical centers that is maintained for potential use in countless sizes which are rarely customized to the patient.

By “single anesthetic”, the present disclosure means that the three-dimensional construct is printed or fabricated within the same operative procedure that created the need for the implant, either through tumor extirpation, fracture reduction, resection of a dysfunctional body part, identification of a missing part, creation of a hole, debridement of nonviable, infected, destroyed tissue or organ, or in the same operative location as the location where the image on which the three-dimensional construct is based is acquired. Also, current devices or methods may refer to “rapid-prototyping”, but this typically means that when the image of a specific part is acquired, it is then sent off to be printed remotely, in a process that may take several days to weeks. With use of the terms “ultra-rapid prototyping”, “intra-operative”, and “single anesthetic”, the present disclosure distinguishes over these processes. In the method of the present disclosure, the required three-dimensional construct can be provided during the same, single surgical procedure. This may all take place while the patient is under anesthesia.

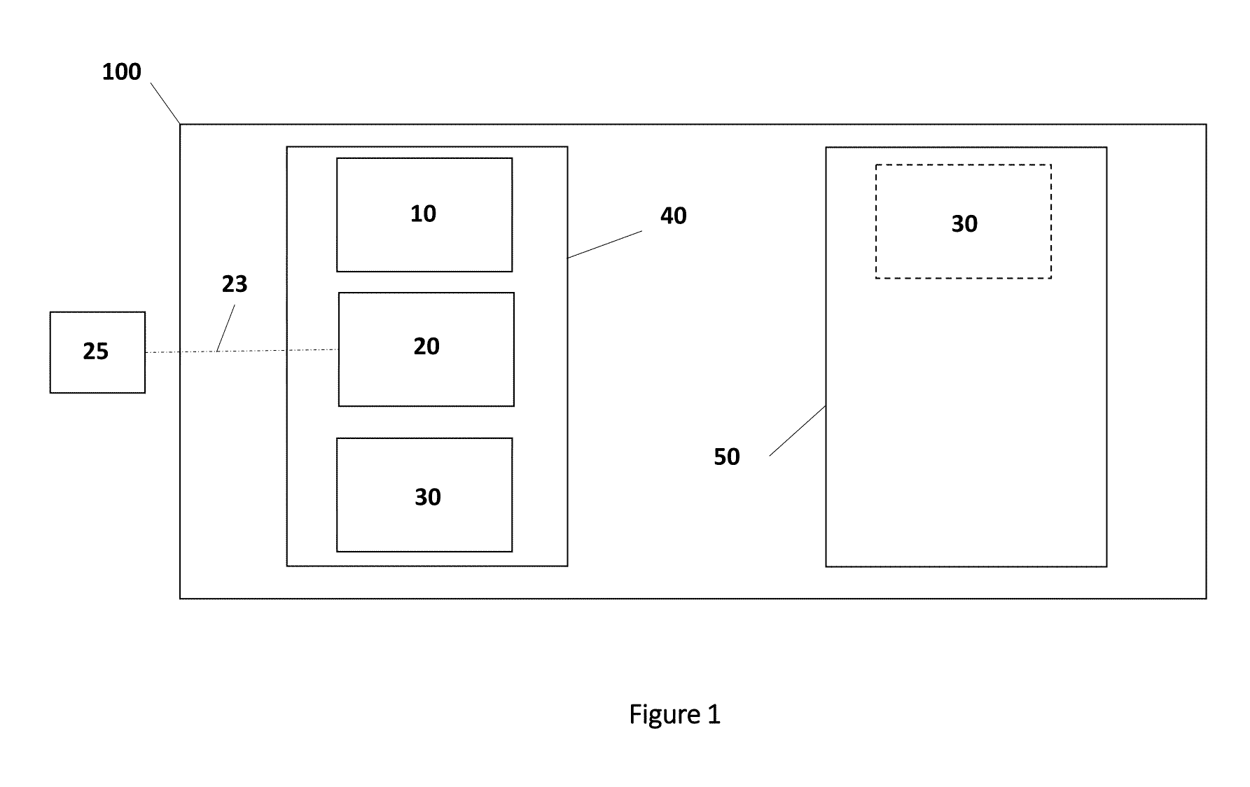

Referring to FIG. 1, a representation of the devices of the present disclosure is shown. Image acquisition device or scanner 10, computer/image display device 20, and printer 30 can all be within the same operating room 40, within medical facility 100. Alternatively one or more of scanner 10, computer 20, and printer 30 could be in an adjacent room 50 (e.g., printer 30). As long as all three of devices 10, 20, and 30 are within the same facility 100, they satisfy the present disclosure's definition of “co-located” or “on-site”. Computer 20 can communicate over a communications link 23 (e.g., broadband, wireless, cabled, Ethernet connections) with a server or database 25. Database 25 can store images and/or data relating to three-dimensional constructs that the user wishes to print out for use. Thus, computer 20 can obtain image data from scanner 10 or from database 25. This image data can then be sent to printer 30 to print the construct. Database 25 can be on site within facility 100, or be located remotely, as shown.

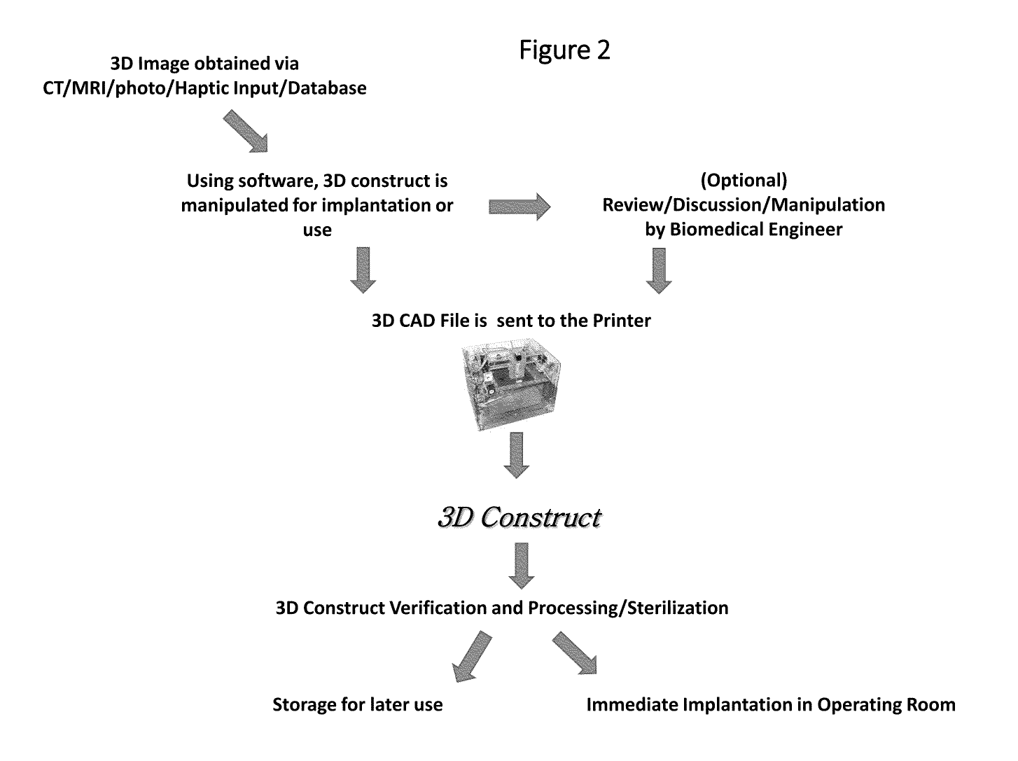

FIG. 2 shows a flow chart of how the process of the present disclosure could take place, in several different embodiments. In the first step, image data relating to the desired three-dimensional construct is acquired. This can be via an image scanning device (e.g. scanner 10), or from a database (e.g., database 25) that has image data stored for any number of implants, prostheses, or surgical tools. The image can be pulled up on a computer or display device (e.g., computer 20). Optionally, the image may be manipulated further by a doctor, engineer, technician, or other user/consultant that can be on- or off-site. After the final image for the construct is agreed upon, the image data is sent to a printer (e.g., printer 30), which fabricates the three-dimensional construct. After this point, the construct can optionally be verified and/or sterilized if need be. The construct can then be placed in the patient, or stored for later use. Whether or not the construct needs sterilization can depend on the method of fabrication and the temperature maintained during fabrication, as well as the location to be used (external as a splinting device, intraoral, or implanted in a closed space). The construct may or may not require subsequent sterilization through autoclave, gas sterilization, etc.

The period of time that the printer or fabricator provides the three-dimensional construct after obtaining the final image can vary, depending on the particular type of medical procedure. This period of time can range from ten minutes to twelve hours, or any subranges there between.

As one example of how the devices and methods of the present disclosure can be used, when conducting surgery to remove a tumor or growth from the orbital cavity, often times part of the skull surrounding the cavity must be removed as well. In currently available methods, surgeons use off-the-shelf replacement bone, which must be carved and shaped before placement in the patient. These off-the-shelf replacements are difficult to work with, and very costly to keep in stock. If the off-the-shelf implement cannot be adjusted suitably (by whittling, bending, cutting, or hitting, all of which induce stress that can lead to device failure once implanted) during the procedure, an additional replacement must be ordered, which can add several additional weeks to the procedure. In a more severe case, the surgical wound in the patient must be left open and bandaged while a customizable implement is ordered. This is obviously very psychologically damaging and dangerous for the patient, in addition to escalating costs associated with operating room time and hospital stays for the patient. Additionally, the wait for a suitable implant or prosthesis results in wound contracture and loss of soft tissue coverage and makes for a much more difficult ultimate reconstruction. This would also require the patient to undergo multiple rounds of anesthesia, which carries its own associated risks. Lastly, the cost of buying implements or prostheses under currently available methods can be extremely high, often as much as $10,000. The methods and devices of the present disclosure allow for producing a myriad of implements and implement devices with material costs of between $1-$100.

Additionally, the present disclosure addresses the deleterious effects of wound contracture, which would occur in the event that an additional or a more definitive three-dimensional construct needs to be designed and placed or replaced at a later time. For instance, in the setting of trauma or infection, a custom implant, which may not be suitable as a permanent device, is impregnated or bathed in antibiotics to allow delivery at the wound site. This implant, which serves as a stop-gap, maintains the soft tissue envelope, thus allowing for implant exchange at a later date.

By contrast, in the present disclosure, once the surgeon identifies the defect or size needed for the three-dimensional construct, a software program resident on the computer (which can be in the operating room itself) can manipulate a 3D image acquired through radiologic imaging, 3D photography, haptic input, 3D positional marker, laser scanner, or via a database of stored images. As described above, the computer has the added capability, in the absence of imaging, to allow the surgeon to rely upon an anthropometric dataset to select the part. With simple intraoperative measurements, the surgeon, or other professional/technician can scale the obtained image as desired, to fit the patient in a nearly identical manner to the patient-specific techniques of the first embodiment, where the patient is scanned.

The 3D rendering of the desired implement can be manipulated through CAD/CAM (computer-aided design or manufacturing) software on the computer located in the operating room by the surgeon, a technician, or with the help of offsite biomedical engineers in order to facilitate production. Even if offsite engineers were used, however, the methods and devices of the present disclosure would work intraoperatively, or when the patient is under a single anesthetic.

Once the surgeon is satisfied with the construct, rapid prototyping commences. The 3D data is then rendered, sliced, and verified within minutes and output to the prototyping machine. The construct is created using fused-deposition modeling (FDM), selective laser sintering (SLS), stereolithography (SLA), electron beam melting (EBM), or any other 3D printing or additive manufacturing process.

The methods and devices of the present disclosure may also use subtractive manufacturing. In this embodiment, the image acquisition device would send an image of a desired three-dimensional construct to the computer, as described above. The final image, with or without modification, is sent to a fabricator. The fabricator uses subtractive methods to produce the three-dimensional construct, where the three-dimensional construct can be hewn from a solid piece of implantable material. The subtractive methods may include lathing the three-dimensional construct, cutting with laser-blade, water-blade, or air-blade-cutting tools, stamping, grinding, or carving.

The present disclosure also contemplates that the imaging of the three-dimensional construct and/or its printing can take place before the patient is placed under anesthesia. For example, in the application described above, an area of the orbital cavity of a patient where bone is missing can be imaged, the image sent to a printer or fabricator, and an already-customized replacement can be ultra-rapidly prototyped. In this example, the turnaround time would be on the lower end of the time period given above, since the image would need to be acquired and the surgery would need to be completed while the patient is still under anesthesia. In procedures where the imaging can take place while the patient is alert before surgery, such as a facial implant procedure, the turnaround time can be closer to the higher end of the range given above. The patient can sit for the construct imaging before being placed under anesthesia, the image can be sent to the printer or fabricator, and then up to twelve hours later the patient can come back to have the construct placed. The cost of the procedure is dramatically reduced as well, lowering the overall costs for the patient and the healthcare system as a whole.

The printer or fabricator of the present disclosure can also eliminate the time associated with sterilization of an implantable prosthesis constructs in currently available devices and methods. Currently, when the doctor or surgeon receives an implantable prosthesis after the printing delay, there is additional time associated with sterilization of the prosthesis, which further adds to the cost of the procedure and risk for the patient. With some of the devices and methods of the present disclosure, however, this time is significantly reduced or eliminated completely. The printer or fabricator can provide an already-sterilized construct (depending on the method of printing and the environment, as described above) for immediate use, for example, due to the high temperatures used in processes like fused deposition modeling, which produces the construct in a sterile manner. In the case of a construct produced via computer-guided lathe, the machining of the construct will still likely still require sterilization, but the lathing process can be more expeditious than printing, so the additional time for sterilization should not be impactive.

The materials suitable for the constructs of the present disclosure may vary. The materials can include titanium, polylactic acid and acrylonitrile butadiene styrene, methylmethacrylate, porous polyethylene, which are approved by the United States Food and Drug Administration for implantable devices. Other materials contemplated may include silk, rubber, light-cured polymers, various metals, and implantable antibioticimpregnated solids. The present disclosure also contemplates the use of all available bio-compatible materials, including suitable plastic, metals, composites, and biologically fabricated tissues.

In addition to being suitable for implanting constructs in patients, the devices and methods of the present disclosure can provide surgical planning models for the doctor and patient. The doctor can hold a model of a bone or skull, for example, and develop a plan of where incisions or bone removal are to take place. The doctor can also illustrate the same to the patient or the patient's caregiver or guardian. As previously mentioned, there is no current method for 3D surgical planning in the short window of composite tissue allotransplantation (i.e. hand transplantation and face transplantation). Due to limitations on tissue survivability, the surgeon must guess how much donor tissue will be required. Guesswork on the recipient tissue resection is the current standard of care, since time does not allow for three dimensional modeling. With this disclosure, the recipient tissue resection as well as the donor resection design could easily be customized to create cutting guides and jigs, allowing for precision cutting of soft tissue and bone. This would save precious time, on the order of 30-60 minutes, allowing the surgeon to focus on microsurgery and enhance rapid tissue perfusion.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A process for producing a three-dimensional construct for a surgical procedure on a patient, comprising the steps of:
acquiring an image of said three-dimensional construct;
displaying the image on a display device;
sending the image to a printer; and
printing the three-dimensional construct according to said image on said printer.

2. The process of claim 1, wherein said printer is co-located in the same facility as the patient during the procedure.

3. The process of claim 1, wherein said display device and said printer are co-located in the same facility as the patient during the procedure.

4. The process of claim 1, wherein said display device is an interactive computer, and the method further comprises the step of allowing a user to modify said image on said computer before sending said image to said printer.

5. The process of claim 1, wherein said acquiring step is conducted by scanning an image of said three-dimensional construct with a three-dimensional scanning device.

6. The process of claim 5, wherein said scanning device, said display device, and said printer are co-located in the same facility as the patient during the procedure.

7. The process of claim 1, wherein said acquiring step is conducted by obtaining an image of said three-dimensional construct from a database that stores data relating to said construct.

8. The process of claim 7, further comprising the step of adjusting said image.

9. The process of claim 1, wherein said patient is under a single anesthetic during the surgical procedure.

10. The process of claim 1, wherein a period of time between said sending step and said printing step is between thirty minutes and twenty-four hours.

11. A medical apparatus for use during a surgical procedure, comprising:
a scanning device for obtaining image data relating to a three-dimensional construct to be used during the surgical procedure;
a computing device to display an image of said three-dimensional construct; and
a printer for printing the three-dimensional construct, wherein said computing device sends said image data relating to said three-dimensional construct to said printer, to print the three-dimensional construct,
wherein at least one of said scanning device, said computing device, and said printer are co-located in the same facility where the surgical procedure takes place.

12. The medical apparatus of claim 11, wherein said printer is co-located within said facility.

13. The medical apparatus of claim 11, wherein said scanning device, said computing device, and said printer are co-located within said facility.

14. The medical apparatus of claim 11, further comprising a database in communication with said computing device, and which stores image data relating to said three-dimensional construct, wherein said computing device obtains image data relating to said three-dimensional construct from at least one of said scanning device and said database.
